(19) United States
(12) Patent Application Publication
(10) Pub. No.: US 2007/0098168 A1
(43) Pub. Date: May 3, 2007

(54) Data protection method and corresponding decoding module

(75) Inventor: Wen Hao Sung, Taipei (TW)

Correspondence Address: MORRISON & FOERSTER LLP, 755 PAGE MILL RD, PALO ALTO, CA, 94304-1018, US

(73) Assignee: Telepaq Technology Inc., Taipei (TW)

(21) Appl. No.: 11/508,595

(22) Filed: Aug. 22, 2006

(30) Foreign Application Priority Data
Oct. 31, 2005 (TW) 094138055

(51) Int. Cl. H04N 7/167

(52) U.S. Cl. 380/228

(57) ABSTRACT

A data protection method and its corresponding decoding module applicable in a digital broadcast system with a subscription mechanism are provided. The data protection method includes an encoding mechanism and a decoding mechanism. The encoding mechanism first encodes broadcast data using a first key and encodes the first key with a second key. The second key is generated from a plurality of keys provided by the encoding mechanism based on an operation rule. The decoding mechanism includes, after verifying usage right of the receiving end, performing decoding using the second key to obtain the first key for the encoded broadcast data; and decoding the encoded broadcast data using the first key, thereby enhancing data security and reducing risks of malicious acquirement of the digital broadcast data.

### FIELD OF THE INVENTION

The present invention relates to a data protection technique, and more particularly, to a data protection method of a digital broadcast system with a subscription mechanism and its corresponding decoding module.

### BACKGROUND OF THE INVENTION

Broadcast technology has been developed for nearly a hundred years, from early AM (Amplitude Modulation) to later developed FM (Frequency Modulation), providing people with a variety of voice data, for example, news, music, traffic update, life information, star talks etc. Prices of radios are now affordable to most people, thus broadcast technology enriches the lives of people and becomes a vital part of people's everyday life at almost no cost.

In recent years, the ability of integrating more and more components in a single integrated circuit and maturity of its techniques have attributed to the transition from analog (AM/FM) technology to Digital Audio Broadcast (DAB) technology. DAB technology broadcasts data in digital form while enabling better sound quality of the audio signal without noise. The increase of bandwidth also allows diversification of broadcast contents. Meanwhile, subscription mechanism can be realized, which not only protects copyrights of the broadcasted contents but also rewards content providers, so they will have more capital to provide better quality of broadcast data, facilitating growth of the digital broadcast system.

Thus, it is necessary to devise certain protection measures for subscribed broadcast data. In other words, broadcast data need to be encoded and decoded using cryptography theory for digital broadcast system with subscription mechanism in order to realized data security and subscription of the broadcast data.

Therefore, application of the encoding and decryption technologies of cryptography to embedded system structures such as PDAs, DAB walkmans, DAB radios or notebook computers allows DAB content provider to realize a subscription mechanism. Subscribers at receiving ends need to be authorized to receive broadcast data.

Generally speaking, there are three steps to realize this mechanism:

A. Encode broadcast data so that data needs to be decoded before use;

B. Encode/decode decoding data required for the encoded broadcast data;

C. Encode authorization message.

For the Eureka 147 European standard, it is one of the most fully developed DAB system at present, the subscription mechanism is called Conditional Access (CA) System. The above steps B and C correspond to the Entitlement Check Message (ECM) and Entitlement Management Message (EMM) in the CA mechanism, respectively, allowing different DAB receiving systems to plan and design their own systems.

Encoding algorithms can be generally divided into two categories: Private-Key System and Public-Key System, wherein Data Encoding Standard (DES) and RSA encoding technique are representatives in the respective category.

Key in the above step A (hereinafter called KA) is encoded and loaded in a ECM, since ECM is an encoding and decoding data that may be frequently executed, so the KA can be encoded using the DES encoding technique, which has better processing speed, the encoding key thereof can be labeled as KB. Whereas in step C (corresponding private key is labeled as KC), RSM encoding technique can be used to encode the authorization message that is critical to the subscription mechanism. The encoded data is loaded to EMM. The EMM data does not require frequent transmission for a single terminal user, thus the more complicated RSM encoding technique (e.g. 512-bit RSM encoding) is more appropriate.

Generally, messages transmitted from a DAB system to a terminal user includes encoded broadcast data, ECM data, EMM data and other data.

On the contrary, the receiving end of the DAB system needs to carry out decoding processes in reverse of the encoding process done by the transmitting end.

Usage right of broadcast service has to be verified at the receiving end before decoding. During decoding, control word KA is firstly decoded from the ECM data, and the control word KA is then used to decode the encoded broadcast data for use. Additionally, when a user uses the service for the first time or extends the service, receiving end receives the EMM data and decodes it to obtain authorization for using the broadcast service.

However, this conventional data protection technique has the following disadvantage that using the DES encoding algorithm to process ECM data, despite that it provides faster processing speed, the encoding information are public. Thus, it is vulnerable to malicious attacks with today's computing speed, in which encoding key (KB) of the DES may be obtained and the encoded broadcast information decoded for illegal use. This causes economical loss to the content provider and infringes copyrights of the contents being stolen, impeding the successful development of digital broadcast service.

Thus, there is a need for a protection method applicable to subscribed broadcast information to ensure broadcast data security, thereby allowing only authorized subscribers to receive digital broadcast service and preventing unauthorized acquirement thereof.

### SUMMARY OF THE INVENTION

In the light of forgoing drawbacks, an objective of the present invention is to provide a highly secured data protection method and its corresponding decoding module.

Another objective of the present invention is to provide a data protection method and its corresponding decoding module that ensures normal operation of a digital broadcast system.

Still another objective of the present invention is to provide a data protection method and its corresponding decoding module that maintains profits of a broadcast data content provider.

Yet another objective of the present invention is to provide a data protection method and its corresponding decoding module that protects the copyrights of broadcast contents.

In accordance with the above and other objectives, the present invention provides a data protection method applicable in a digital broadcast system with a subscription mechanism and including a transmitting end and a receiving end. The data protection method comprises: generating an encoding mechanism by the transmitting end, the encoding mechanism including: (1) encoding broadcast data to be sent using a first key to generate an encoded broadcast data; and (2) encoding the first key using a second key to generate a verifying message, wherein the second key is generated from a plurality of keys provided by the encoding mechanism based on an operation rule, and the transmitting end sending the encoded broadcast data and the verifying message; receiving said encoded data and verifying message to generate a decoding mechanism, the decoding mechanism including: after verifying usage right of the receiving end, performing decoding using the second key to obtain the first key for the encoded broadcast data; and decoding the encoded broadcast data using the first key.

The transmitting end further comprises encoding the usage right with a third key to generate an authorization management message. Correspondingly, the receiving end compares a device identification code contained in the authorization management message with a device identification code of the receiving end, and after comparison, performs a decoding using the third key to obtain the usage right of the authorization management message and updates the original usage right of the receiving end.

The decoding module applicable in a receiving end of a digital broadcast system is used to perform decoding on the encoded data, such that only authorized user is allowed to access the broadcast data. The decoding module comprises: a storage unit for storing a usage right, a device identification code, a plurality of DES key and a RSA key; and a processing unit for verifying the usage right of the receiving end, and when the receiving end being validated, performing the decoding using the DES key to obtain a key for the encoded broadcast data to further perform decoding on the encoded broadcast data.

The processing unit further compares a device identification code in the authorization management message with a device identification code of the decoding module, and after validating a user of the decoding module to be a legal subscriber, performs decoding using the RSA key to obtain the usage right in the authorization management message and update the usage right in the storage unit.

Thus, the data protection method of the present invention and corresponding decoding module enhances security of broadcast data and prevents unauthorized acquirement of the digital broadcast data by malicious third party, ensuring normal operation of the digital broadcast system and protecting the rights of the broadcast data.

### BRIEF DESCRIPTION OF THE DRAWINGS

The present invention can be more fully understood by reading the following detailed description of the preferred embodiments, with reference made to the accompanying drawings, wherein:

FIG. 1A and FIG. 1B are flowcharts showing the operating procedures of the data protection method of the present invention.

FIG. 2 is a block diagram showing the decoding module of the present invention.

FIG. 3 shows a schematic application diagram of a first embodiment of the decoding module of the present invention.

FIG. 4 shows a schematic application diagram of a second embodiment of the decoding module of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

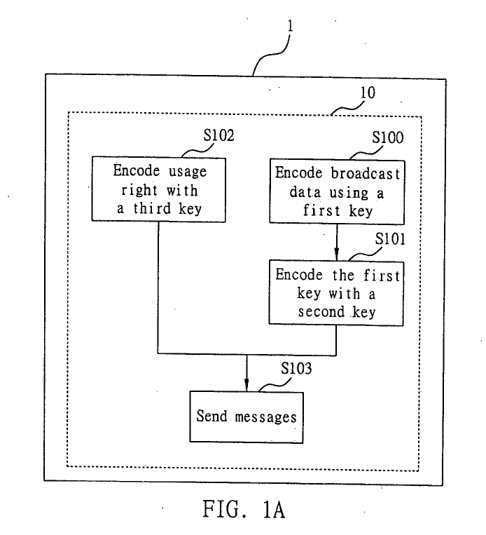

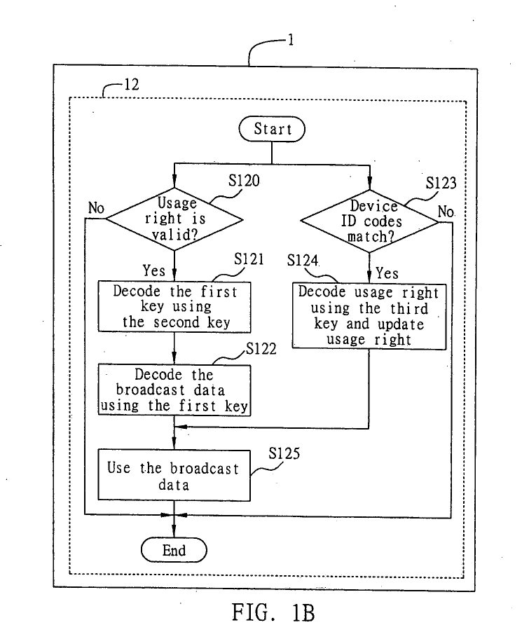

FIG. 1A and FIG. 1B are flowcharts showing the operating procedures of the data protection method of the present invention. In the following embodiments, the data protection method of the present invention is applied to a digital broadcast system 1 providing digital broadcast service with subscription mechanism and including a transmitting end 10 and a receiving end 12.

First, the transmitting end 10 generates an encoding mechanism in order to encode broadcast data to be sent.

In step S100, a first key is used to encode the broadcast data to be sent to generate an encoded broadcast data. In this embodiment, the first key is a set of random numbers used as an encryption key for the broadcast data, which randomly changes every certain period. At the receiving end, the same key has to be used for carrying out the decoding process. Since the encoding method of the broadcast data is a well-know technique in the DAB art, it will not be described in detail.

In step S101, a second key is used to encode the first key to generate a verifying message, wherein the second key is generated from a plurality of keys provided by the encoding mechanism based on an operation rule. In this embodiment, the first key is encoded by the Data Encryption Standard (DES) technique, wherein the number of keys can vary according to the level of security. The operation rule is a privately designed Hash function having random characteristic, so that the second key is randomly generated from the plurality of keys. The second key is then embedded into ECM along with a key value used by the Hash function in generating the second key. Digital broadcast system 1 sends an ECM containing the second key at certain interval (e.g. 24 seconds), so that there will not be enough time for illegal attempts to decode.

In step S102, a third key is used to encode the usage right to generate a authorization management message. In this embodiment, the encoding of usage right is executed by using the RSA encoding system. The third key is a public key. The authorization management message includes management information such as user name, address, smart card number and billing list etc. The authorization management message is sent along with other data when the user first starts using the system or after extending subscription period. Since the RSA operation is more complicated and takes relative longer time, thus this message is not frequently sent for users with a single subscription, reducing its impact to system performance. Step S103 is performed.

In step S103, the transmitting end 10 sends out the processed messages including the encoded broadcast data, verifying message and authorization management message by using a multiplexer, for example.

The broadcast data, the first key and the information related to usage right are respectively encoded using the first key, the second key and the third key by the encoding mechanism at the transmitting end 10, in which the second key is selected randomly from a plurality of pre-generated keys, enhancing the security of broadcast data and preventing any unauthorized acquirement of the digital broadcast data.

Please refer to FIG. 1B, the receiving end 12 generates a decoding mechanism in order to perform decoding procedures on the encoded broadcast data sent by the transmitting end 10.

In step S120, usage right of the receiving end 12 is verified. For example, for a limit-by-channel system, it is determined whether the subscriber has right to access the broadcast data of a certain channel; for a limit-by-time system, it is determined whether the subscription time is still within the valid date; for a limit-by-traffic system, it is determined whether the amount of data traffic is still within the allowed range. If the usage right is validated, then step S121 is performed; else, the operation ends and any subsequent steps are denied.

In step S121, after the usage right is validated, the first key of the encoded broadcast data is obtained by executing a decoding process using the second key. In this embodiment, the decoding process is a DES decoding process, which selects from a plurality of keys stored at the receiving end 12 a key that is equal to the second key sent by the transmitting end 10 for the decoding process. Thereafter, step S122 is performed.

In step S122, the decoded first key is then used to decode the encoded broadcast data, since this decoding method for decoding the broadcast data is well-known in the art, it will not be further described.

In step S123, if the data transmitted by the transmitting end 10 includes the authorization management message, then the receiving end 12 can compare the device identification code of the authorization management message and the device ID code of the receiving end 12 itself to verify whether the receiving end 12 is a subscriber of the digital broadcast system 1. In this embodiment, the device ID code of the receiving end 12 can be recorded in the storage unit of its memory when fabricated, which is usually unchangeable and uniquely identifies the receiving end 12. If the comparison matches, then step S124 is performed; else, the method ends.

In step S124, the third key is used for the subsequent decoding process which acquires the usage right of the authorization management message, the usage right of the receiving end 12 is updated and stored in the receiving end 12. In this embodiment, the third key is a private key of the RSA encoding system, which is also recorded in the storage unit of the memory when the receiving end 12 is fabricated in order to prevent stealing by malicious third party. Step S125 is then performed.

In step S125, the receiving end 12 is legally allowed to use the decoded broadcast data.

In summary of the above, the data protection method of the present invention and its corresponding decoding module increases the security of data being broadcast while further preventing unauthorized acquirement of the digital broadcast data to ensure the normal operations of the digital broadcast system and maintain the rights of the content providers.

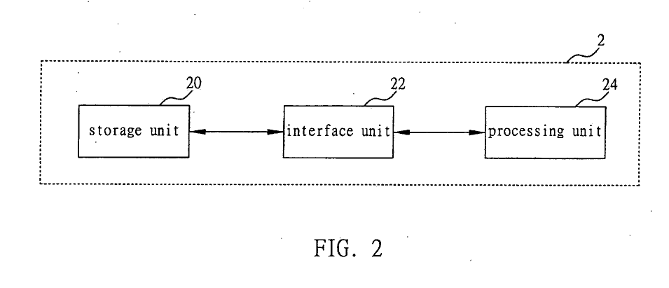

FIG. 2 is a block diagram showing the decoding module of the present invention. The decoding module 2 of the present invention applicable in the receiving end of the digital broadcast system is used to decode the broadcast data being encoded for use by the authorized subscriber. The decoding module 2 comprises a storage unit 20, an interface unit 22 and a processing unit 24. The decoding module 2 is an electronic device capable of receiving digital broadcast, which can be any type of portable electronic device, such as MP3 player, memory bar, mobile phone, Personal Digital Assistant (PDA), notebook etc. For the purpose of illustration, only those aspects related to the decoding module 2 are described in the following embodiments and depicted in the corresponding drawings.

The storage unit 20 is a secure data unit for storing messages such as usage right, device ID code, a plurality of DES keys, RSA key and software program code (including the private Hash function equal to that of the transmitting end). The storage unit 20 is a Random Access Memory (RAM) plus a Flash ROM. The usage right indicates the usage channel, valid usage period and amount of data traffic, which can be updated if required and stored in the storage unit 20. The software program code is used to load the decoding program. The device ID code is recorded in the storage unit 20 of the decoding module 2 when fabricated to uniquely identify the decoding module 2. The number of DES keys corresponds to the number of DES keys at the transmitting end 10 of the digital broadcast system 1 for decoding the verifying message. The RSA key is a private key of the RSA encoding system in order to acquire a usage right after the RSA decoding process. The usage right is also recorded in the memory unit 20 of the decoding module 2 when fabricated to prevent stealing by malicious third party.

The processing unit 24 accesses the usage right in the storage unit 20 via the interface unit 22 and verifies it. If the usage right is determined to be valid, then the Hash function is executed to obtain the correct second key (i.e. DES key) based on the data loaded in the ECM, such that the first key for the encoded broadcast data can be obtained by further executing the decoding process using the second key. Thereafter, the encoded broadcast data is decoded by the decoded first key. The DES keys are equal to the DES keys at the transmitting end 10. The processing unit 24 further compares the device ID code in the authorization management message with the device ID code of the decoding module 2. After it is determined that the user is a subscribed user, another decoding process can be executed using the RSA key to obtain the usage right of the authorization management message and also update the usage right in the storage unit.

Decoding processes in reverse of the encoding processes for broadcast data at the transmitting end can be realized through the decoding module 2 in order to ensure the legal usage right of broadcast data by the subscribed user.

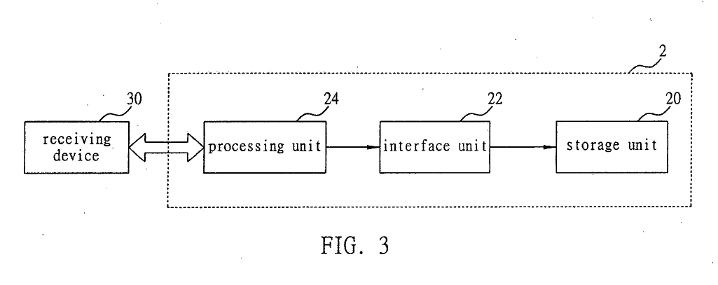

FIG. 3 shows a schematic application diagram of a first embodiment of the decoding module 2 of the present invention. In the first embodiment, the decoding module 2 is integrally provided in a receiving device 30. As shown in the diagram, the decoding module 2 of the first embodiment comprises the storage unit 20, the private interface unit 22 and the processing unit 24.

The storage unit 20 can be an ASIC or closed module for storing the device ID code of the decoding module 2, the plurality of DES decoding keys, the RSA private key, the usage right and the software program code.

The processing unit 24 accesses the storage unit 20 via the private interface unit 22 to verify the user, reads and executes the software program code in the storage unit 20, and further establishes connection with the receiving device to perform decoding process on the encoded broadcast data received.

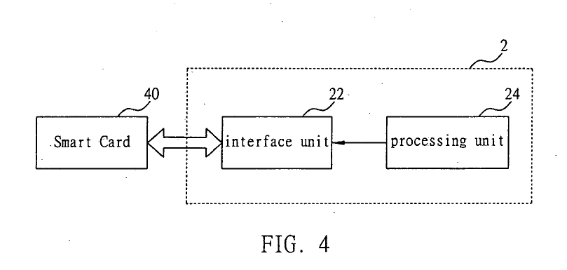

FIG. 4 shows a schematic application diagram of a second embodiment of the decoding module 2 of the present invention. The second embodiment integrates the decoding module 2 into a Smart Card (e.g. Secure Digital Card in this example) 40. The Smart Card 40 is equivalent to the storage unit 20. The interface unit 22 is compliant with the standard access flow defined in the published “Content Protection for Recordable Media Specification, SD Memory Card Book—Common Port” and “SD Memory Card Specification—Part 3 Security Specification”, such that the contents in the Smart Card 40 can be protected from malicious acquirement. As shown, the decoding module 2 of the second embodiment comprises a storage unit (i.e. the Smart Card 40), a public interface unit 22 and a processing unit 24.

The Smart Card 40 is used for storing the device ID code of the decoding module 2, the plurality of DES decoding keys, the RSA private key, the usage right and the software program code.

When the processing unit 24 is activated, the software program code stored in the storage unit (i.e. the Smart Card 40) is read and executed to verify the user. After the user is validated, the encoded broadcast data received can be decoded, wherein the decoding module 2 has to be able to interact with the standard memory device to load the program code therein, so as to execute basic system initialization for driving the interface unit 22.

The separated device-and-card configuration of the second embodiment increases usage flexibility and user application of the decoding module 2. The main system with subscription mechanism of the present invention can be related only to the Smart Card 40 and not limited to certain receiving device. For example, the user only needs to have a Smart Card 40 containing the usage right and decoding mechanism to be able to acquire and use encoded broadcast data received by any type of receiving device with appropriate input port. Thus, the user may receive broadcast data in a mobile phone, a notebook or any hardware device capable of receiving digital broadcast data and interact with the Smart Card 40. It is not necessary to buy a particular hardware device, which increases flexibility of use and facilitates the spreading of the broadcast system.

Thus, the data protection method of the present invention and corresponding decoding module enhances security of broadcast data and prevents unauthorized acquirement of the digital broadcast data by malicious third party, ensuring normal operation of the digital broadcast system and profit of the content provider.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed as new and desired to be protected by Letters Patent of the United States is:

1. A data protection method applicable in a digital broadcast system with a subscription mechanism and including a transmitting end and a receiving end, the data protection method comprising:
generating an encoding mechanism by the transmitting end, the encoding mechanism including:
encoding broadcast data to be sent by using a first key to generate an encoded broadcast data; and
encoding the first key by using a second key to generate a verifying message, wherein the second key is generated from a plurality of keys provided by the encoding mechanism based on an operation rule, allowy the transmitting end to send the encoded broadcast data and the verifying message; and
receiving said encoded data and verifying message to generate a decoding mechanism, the decoding mechanism including:
after verifying usage right of the receiving end, performing decoding by using the second key to obtain the first key for the encoded broadcast data; and
decoding the encoded broadcast data by using the first key.

2. The data protection method of claim 1, wherein the transmitting end further comprises encoding the usage right with a third key to generate an authorization management message.

3. The data protection method of claim 2, wherein the receiving end compares a device identification code contained in the authorization management message with a device identification code of the receiving end, and after comparison, performs a decoding by using the third key to obtain the usage right of the authorization management message and updates the original usage right of the receiving end.

4. The data protection method of claim 2, wherein the authorization management message further comprises an identification code of the transmitting end.

5. The data protection method of claim 1, wherein the operation rule is a private Hash function.

6. The data protection method of claim 1, wherein the second key is a Data Encryption Standard (DES) key.

7. The data protection method of claim 1, wherein the third key is a RSA key.

8. A decoding module applicable in a receiving end of a digital broadcast system integrated in a smart card, such that a receiving device coupled to the smart card is able to perform the decoding on an encoded broadcast data of claim 1, the decoding module comprising:
a storage unit for storing a usage right, a device identification code, a plurality of DES key and a RSA key; and
a processing unit for verifying the usage right of the receiving end, and when the receiving end being validated, performing the decoding using the DES key to obtain a key for the encoded broadcast data to further perform decoding on the encoded broadcast data.

9. The decoding module of claim 8, wherein the storage unit further comprises a software program to be loaded and executed by the processing unit for decoding.

10. The decoding module of claim 8, wherein the storage unit is a random access memory and a flash read only memory.

11. The decoding module of claim 8, wherein the processing unit further compares a device identification code in an authorization management message sent by the transmitting end with a device identification code of the decoding module, and after validating a user of the decoding module to be a legal subscriber, performs decoding using the RSA key to obtain a usage right in the authorization management message and update the usage right in the storage unit.
